(19) United States
(12) Patent Application Publication
(10) Pub. No.: US 2015/0070586 A1
(43) Pub. Date: Mar. 12, 2015

(54) SYSTEM AND METHOD TO VIEW PROPERLY ORIENTED CLOSED CAPTIONING DIRECTLY AND THROUGH REFLECTIONS

(71) Applicants: Sony Network Entertainment International LLC, Los Angeles, CA (US); Sony Corporation, Tokyo (JP)

(72) Inventors: Charles McCoy, Coronado, CA (US); Leo Pedlow, Ramona, CA (US); True Xiong, San Diego, CA (US)

(73) Assignees: Sony Network Entertainment International LLC, Los Angeles, CA (US); Sony Corporation, Tokyo (JP)

(21) Appl. No.: 14/021,722

(22) Filed: Sep. 9, 2013

(51) Int. Cl. H04N 13/04

(52) U.S. Cl. CPC H04N 13/0497
USPC 348/588

(57) ABSTRACT

A system and method for viewing simultaneous videos on a single display device using polarization. The system includes a polarized display device capable of displaying multiple full-screen polarized images simultaneously, multiple polarized videos displayed on the display device, and at least one polarizing optical element. The polarizing optical element includes a direction of polarization generally equal to the direction of polarization of one of the polarized videos, so that only one polarized video is viewable through the polarizing optical element. The polarizing optical element may be a transparent window or a mirror. Multiple polarizing optical elementes may be used simultaneously, allowing for simultaneous viewing of multiple videos displayed on a single screen.

### BACKGROUND OF THE INVENTION

1. Field of the Invention

The present invention relates generally to systems for viewing of polarized video content, and more specifically to viewing of different display content simultaneously on a single display screen.

2. Discussion of the Related Art

Polarized display screen technology is typically used to provide a three-dimensional viewing experience of a video on a flat screen. Two different videos are displayed simultaneously on the screen. Each video consists of polarized light, with the two videos having different directions of polarization. To achieve the 3D effect, typically the videos are similar, with a slight offset. Polarized glasses are provided, where the polarization of one lens matches the polarization of the video intended to be viewed by that eye, and the polarization of the other lens matches the polarization of the video intended to be viewed by the other eye. Thus, each eye views a separate video, producing a 3D effect.

Another example of use of polarized display screen technology involves use of polarized videos so that two viewers view different full-screen videos on the same display screen. Each viewer wears polarized glasses where the polarization of both lenses matches the polarization of the viewed video.

### SUMMARY OF THE INVENTION

The invention provides a polarized video viewing system wherein at least two polarized videos are superimposed on a video display and played simultaneously, wherein a viewer views only one polarized video when viewed through a polarized optical element.

In one embodiment, the invention can be characterized as a video display system including means for displaying at least two polarized videos simultaneously, at least two polarized videos, and a first polarized optical element. Each polarized video includes a discrete direction of polarization, and the polarization of the polarized optical element is generally equal to the direction of polarization of one of the polarized videos, so that only one polarized video is viewable when viewed through the first polarized optical element.

In another embodiment, the invention can be characterized as a method for viewing a polarized video through a polarized optical element comprising the steps of: providing a video display screen including means for displaying at least two polarized videos simultaneously; providing at least two polarized videos displayed simultaneously on the display screen, each video including a discrete direction of polarization; providing at least one polarized optical element, wherein the direction of polarization of the polarized optical element is generally equal to the direction of polarization of one of the polarized videos, whereby only one of the polarized videos is viewable when viewed through the polarized optical element; and viewing of the video display screen through the polarized optical element, whereby only the polarized video including the direction of polarization of the polarized optical element is viewable.

In yet another embodiment, the method can be characterized as a method for viewing a polarized video through a polarized optical element comprising the steps of: providing a video display screen including means for displaying at least two polarized video channels simultaneously; providing a first polarized video channel; providing a second polarized video channel, whereby the first and second video channels are displayed simultaneously on the video display screen, wherein each polarized video channel includes a discrete direction of polarization; providing a polarized window, wherein the direction of polarization of the polarized window is generally equal to the direction of polarization of the first polarized video channel, whereby only the first polarized video channel is viewable when viewed through the polarized window; providing a polarized mirror, wherein the direction of polarization of the polarized mirror is generally equal to the direction of polarization of the second polarized video channel, whereby only the second polarized video channel is viewable when viewed reflected by the polarized mirror; viewing of the first polarized video channel through the polarized window; and viewing of the second polarized video channel through the polarized mirror.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a perspective view of components of a polarized video display system in accordance with an embodiment of the present invention

FIG. 2 is an exploded schematic view of components of the polarized video display system in accordance with an embodiment of the present invention.

FIG. 3 is a perspective view of components of the polarized video display system including a polarized window in accordance with an embodiment of the present invention.

FIG. 4 is a perspective view of components of the polarized video display system including a polarized mirror in accordance with an embodiment of the present invention.

FIG. 5 is a perspective view of the polarized video display system in accordance with an embodiment of the present invention.

FIG. 6 is a perspective view of components of the polarized video display system including polarized glasses in accordance with an embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

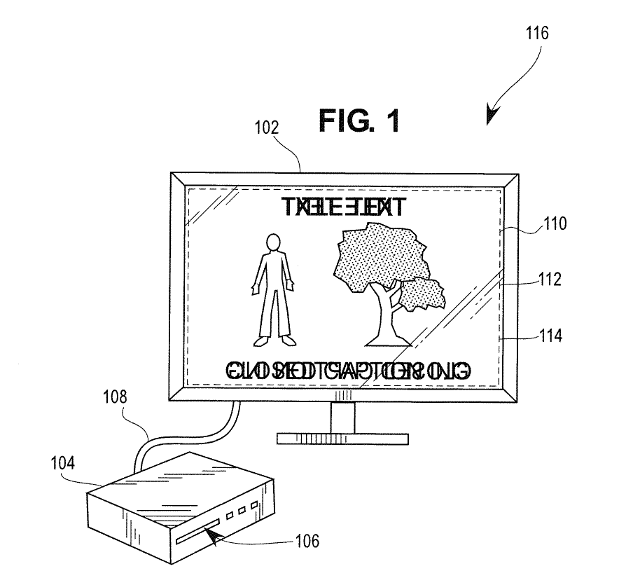

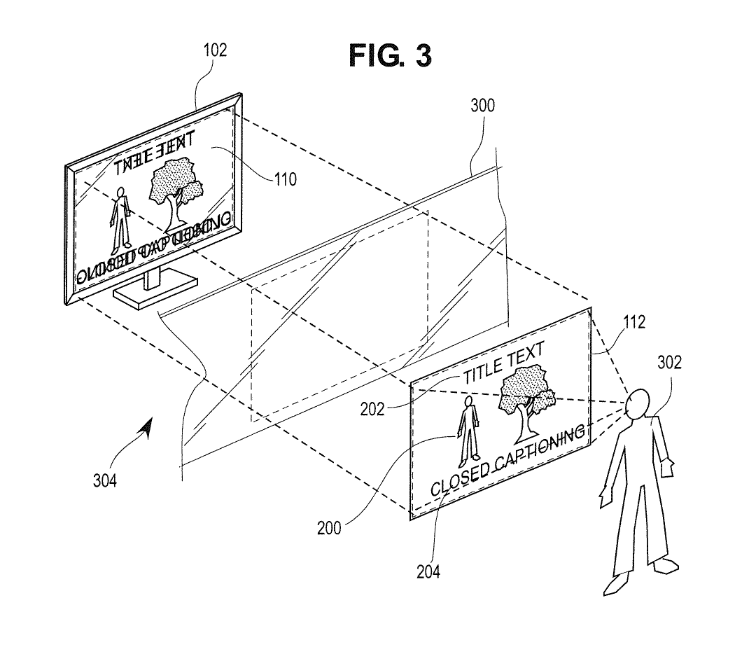

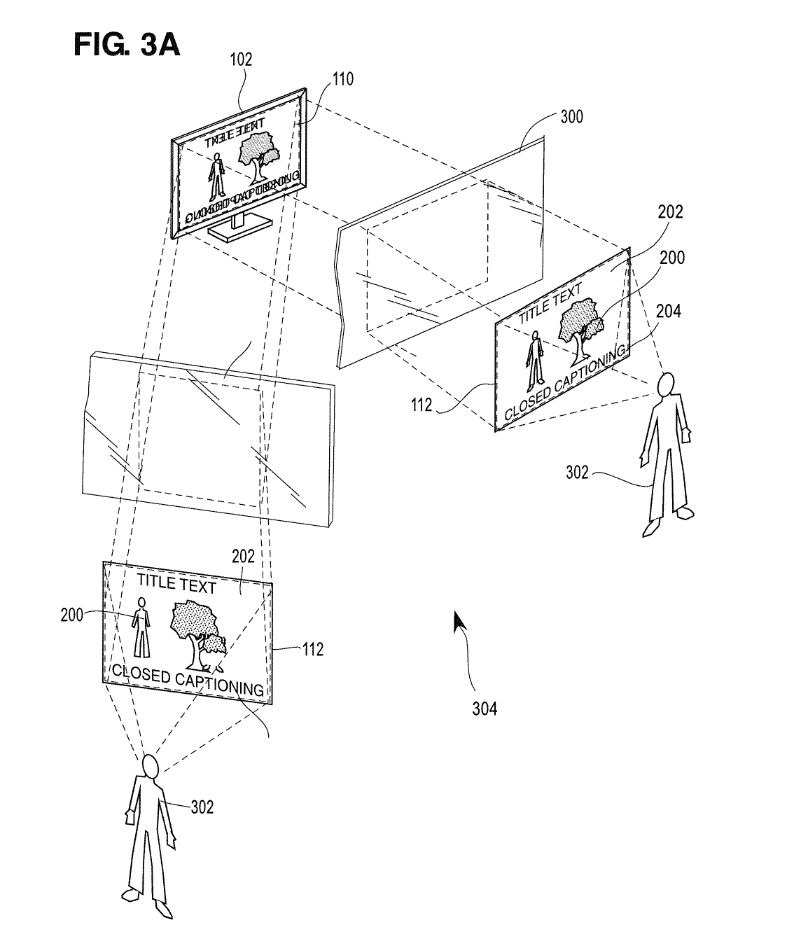

Referring first to FIG. 1, a plurality of display components 116 of the polarized video display system 304 (as shown below in FIG. 3) in one embodiment of the present invention are shown. Shown are a polarized video display device 102, a polarized video player 104, a polarized video disc 106, a player-display connection 108, a polarized video 110, a first polarized video channel 112, and a second polarized video channel 114.

The polarized video display device 102 receives and displays the polarized video 110. The polarized video display device 102 may be any device suitable for receiving and displaying at least two polarized videos simultaneously, for example a polarized 3D television. In the exemplary polarized video display system components 116 shown in FIG. 1, the displayed polarized video 110 is encoded onto the video disc 106, for example a Blu-ray disc, and played using the polarized video player 104, e.g. a 3D Blu-ray player capable of playing polarized video. The polarized video player 104 is electrically coupled to the polarized video display device 102 by the player-display connection 108, for example an HDMI cable, or other suitable means for transferring the polarized video 110 from the polarized video player 104 to the polarized video display device 102. The skilled artisan will appreciate that other suitable methods may be available for receiving and transferring the polarized video 110 to the polarized video display device 102, e.g. internet protocol video streaming.

In the exemplary display components 116 shown in FIG. 1, the polarized video 110 includes two polarized video channels: the first polarized video channel 112 and the second polarized video channel 114. The two polarized video channels 112 114 are displayed simultaneously on the polarized video display device 102. Each video channel 112 114 is displayed over the full extent of the polarized video display device 102.

The first polarized video channel 112 and the second polarized video channel 114 are displayed with discrete directions of polarization. The polarization may be circular or linear. For example, the direction of polarization of the first polarized video channel 112 could be clockwise and the direction of the second polarized video channel 114 could be counter-clockwise (using circular polarization). The result of the discrete directions of polarization is that an optical element polarized in the same direction as a polarized video channel will block all other polarized video channels and permit viewing of only the polarized video channel with the direction of the polarized video channel generally equal to the direction of polarization of the optical element.

When the polarized video disc 106 is played using the polarized video player 104, the polarized video 110 encoded on the polarized video disc 106 is transferred to the polarized video display device 102 via the player-display connection 108 and is viewable on the polarized video display device 102. As the polarized video 110 includes at least two discrete video channels 112 114, played simultaneously, if different videos are displayed on each channel, this will result in some or all portions of the videos being garbled when viewed as displayed on the polarized video display device 102, as shown in FIG. 1. Viewing of only one of the polarized video channels 112 114 requires viewing through the polarized optical element (referred to below in FIGS. 3-6).

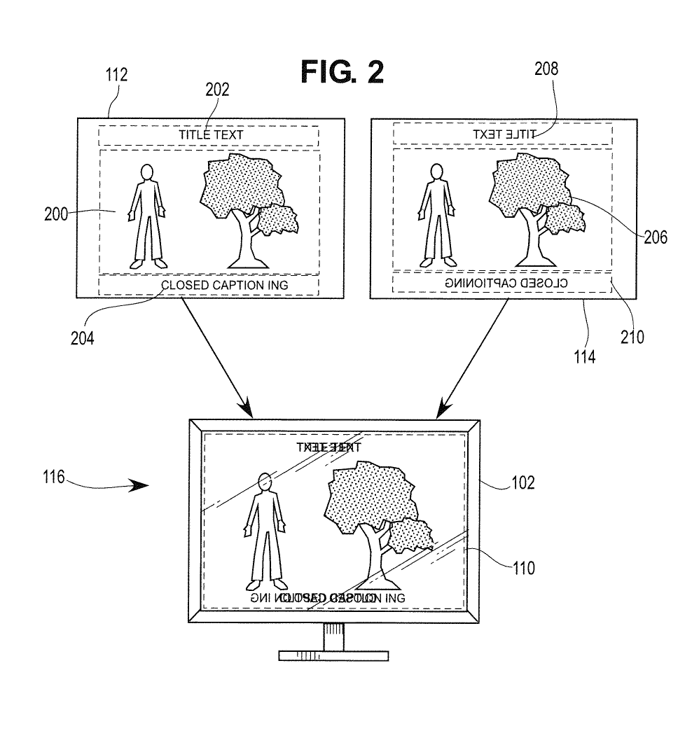

Referring next to FIG. 2, an exploded view of the display component 116 of the polarized video display system 304 (as shown below in FIG. 3) is shown. Shown are the first polarized video channel 112, the second polarized video channel 114, the polarized video 110, the polarized video display device 102, a plurality of first polarized images 200, a first title text 202, a first closed captioning text 204, a plurality of second polarized images 206, a second title text 208, and a second closed captioning text 210.

The polarized video display device 102 is shown with the polarized video 110 displayed on the device 102. In the present embodiment of the invention, the polarized video 110 includes the two polarized video channels, the first polarized video channel 112 and the second polarized video channel 114, displayed simultaneously. To illustrate the differences between the exemplary polarized video channels 112 114, they are shown separately in FIG. 2. The first polarized video channel 112 includes the plurality of first polarized images 200, the first title text 202 and the first closed captioning text 204. The plurality of first polarized images 200, the first title text 202 and the first closed captioning text 204 are all displayed normally on the screen, i.e. how images and text would normally be displayed on a video screen without polarization.

The second polarized video channel 114 includes the plurality of second polarized images 206, which in the embodiment shown are identical to the first polarized images 200 displayed in the first polarized video channel 112. The second title text 208 and the second closed captioning text 210 comprise the same text as the first title text 202 and the first closed captioning text 204, respectively, but with the text mirrored about a vertical axis, so that the text is readable when viewed in a mirror.

As previously described in FIG. 1, the video channels 112 114 each have a different direction of polarization. The video channels 112 114 are displayed simultaneously as the polarized video 110 on the video display device 102, as shown in FIG. 2.

Referring again to FIG. 2, the simultaneous display of the two discrete polarized video channels 112 114 comprising the polarized video 110 allows for separate images and text to be displayed and viewed at the same time. The exemplary display system shown in FIG. 2 includes the first polarized video channel 112, where the images and text are displayed as they would be normally viewed on a non-polarized display, and the second polarized video channel 114, which differs from the first polarized video channel 112 in that the text is mirrored. Thus, when the second polarized video channel 114 is viewed through polarizing means and reflected in a mirror, the text is in a readable orientation. An alternate embodiment could include the plurality of second polarized images 206 also being mirrored about a vertical axis, so that the second polarized video channel 114 viewed through polarizing means that includes a mirror would be identical to the first polarized video channel 112. Alternately, partially or entirely different images and text may be displayed on the video channels 112 114.

The exemplary mirrored text includes the second title text 208 and the second closed captioning text 210. The second title text 208 includes graphic text included with video content, such as a title or credits. The second closed captioning text 210 includes the text version of the audio associated with the polarized video channel displayed, and is encoded with the second polarized video channel 114. The closed captioning is typically viewed when it is desirable to watch video content without listening to the audio. Those skilled in the art will note that any other text or other images appearing in the mirrored second polarized video channel 114 that would be adversely affected by mirroring may be also be mirrored.

Displaying the first and second polarized video channels 112 114 simultaneously on the polarized video display device 102 allows for a viewer 302 (as shown below in FIG. 3) to view only the first polarized video channel 112 or only the second polarized video channel 114, when the viewer 302 views the device through polarizing means as shown below in FIGS. 3-6.

Referring next to FIG. 3, shown is polarized video display system 304, the polarized video 110, the polarized video display device 102, the first polarized video channel 112, the plurality of first polarized images 200, the first title text 202, the first closed captioning text 204, a polarized window 300, the first polarized video channel 112 and the viewer 302.

The polarized video 110 is shown displayed on the polarized video display device 102. The viewer 302 views the polarized video display device 102 at a distance from and angle to the plane of the polarized video display device 102 that permits viewing of the displayed polarized video 110. The polarized window 300 is located between the viewer 302 and the polarized video display device 102. As used in this description and in the appended claims, the word ‘window’ means a pane of transparent material whereby the viewer views objects through the window using both eyes.

In the exemplary polarized video display system 304, the plane of the polarized window 300 is oriented generally parallel to the plane of the polarized video display device 102. The polarized window 300 may be angled with respect to a horizontal axis, with respect to a vertical axis, or with respect to both axes.

The polarized window 300 may be made of glass or any other suitable polarizable transparent material. The planar dimension of the polarized window 300 may be of any dimension suitable for manufacture and installation of the polarized window 300 and suitable for viewing of the polarized video display device 102 through the polarized window 300.

In the exemplary system 304, the direction of polarization of the polarized window 300 is generally equal to the direction of polarization of the first polarized video channel 112. The polarization may be circular or linear. This permits only light with the direction of polarization of generally equal to the direction of polarization of the first video channel to be viewed through the polarized window 300. Thus, when viewed through the polarized window 300, the viewer 302 sees only the display of the first polarized video channel 112, including the plurality of first polarized images 200, the first title text 202 and the first closed captioning text 204. As shown in FIG. 2, the images and the text in the first polarized video channel 112 are displayed and viewed un-mirrored, i.e. oriented as one would see the images and the text as displayed conventionally on a display screen.

Thus, while at least two polarized video channels 112 114 are displayed on the polarized video display device 102 simultaneously, the viewer 302 views only the first polarized video channel 112.

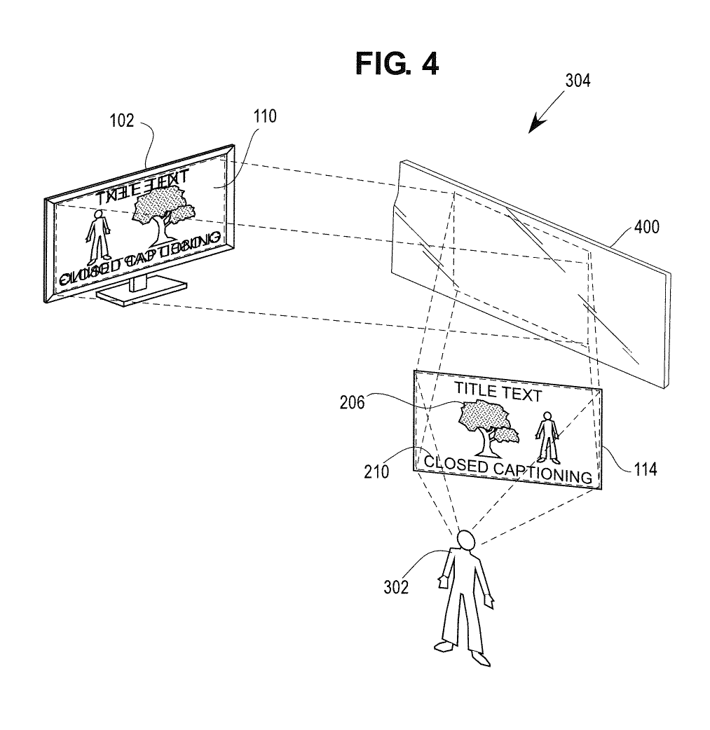

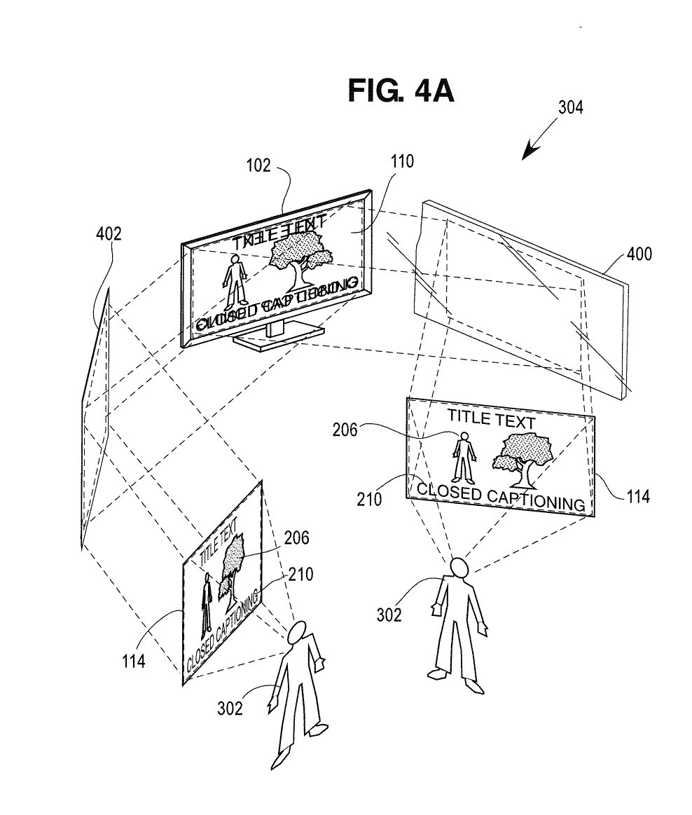

Referring next to FIG. 4, shown is polarized video display system 304, the polarized video 110, the polarized video display device 102, the polarized mirror 400, the second polarized video channel 114, the plurality of second polarized images 206, the second title text 208, the second closed captioning text 210, and the viewer 302.

The polarized video 110 is shown displayed on the polarized video display device 102. In the present embodiment, the plane of the polarized mirror 400 is oriented generally parallel to the plane of the polarized video display device 102. The polarized mirror 400 is located at a distance from and angle to the plane of the polarized video display device 102 so that the polarized video 110 is viewable when the viewer 302 views the polarized mirror 400.

The viewer 302 is located at a distance from and angle to the polarized mirror 400 so that the polarized video 110 is viewable by the viewer 302 looking at the polarized mirror 400. The polarized mirror 400 may be made of mirrored polarized glass, or other material suitable for reflecting and polarizing light. The direction of polarization of the polarized mirror 400 is generally equal to the direction of polarization of the second polarized video channel 114. The polarization may be circular or linear. Alternately, the combination of a non-polarized mirror viewed through a polarized window may be used to achieve the same result.

In the exemplary polarized video display system 304, the vertical plane of the polarized mirror 400 is oriented generally parallel to the vertical plane of the polarized video display device 102. The horizontal axis of the polarized mirror 400 is generally angled with respect to the horizontal axis of the plane of the display device 102.

Referring again to FIG. 4, since the direction of polarization of the polarized mirror 400 is generally equal to the direction of polarization of the second polarized video channel 114, only the second polarized video channel 114 is reflected by the polarized mirror 400. Thus, while at least two polarized video channels 112 114 are displayed on the polarized video display device 102 simultaneously, the viewer 302 views only the second polarized video channel 114.

Additionally, the second polarized video channel 114 includes the plurality of second polarized images 206, the second title text 208 and the second closed captioning text 210. As shown in FIG. 2, the second title text 208 and the second closed captioning text 210 are mirrored about a vertical axis. As a result, when reflected by the polarized mirror 400 the second title text 208 and the second closed-captioning text 210 are un-mirrored and are readable. In the embodiment shown, the plurality of second polarized images 206 are displayed un-mirrored in the second polarized video channel 114, and thus appear mirrored when the second polarized video channel 114 is viewed as reflected in the polarized mirror 400. The skilled artisan will note that the second polarized images 206 may also be mirrored in the second polarized video channel 114.

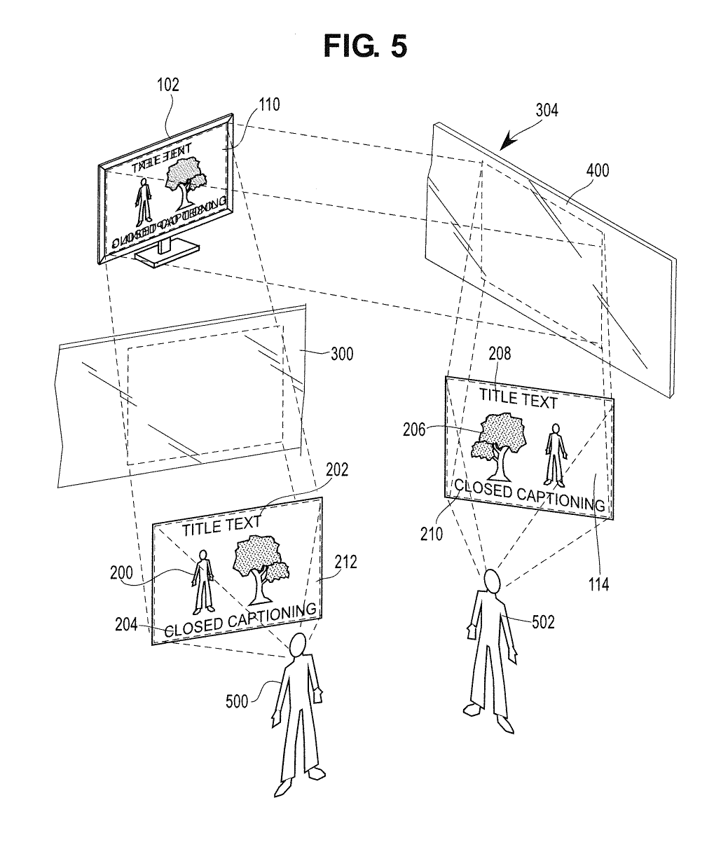

Referring next to FIG. 5, viewing of the first and second video channels 112 114 displayed simultaneously on the single polarized video display device 102 is shown. Shown are the polarized video display device 102, the first and second video channels 112 114, the polarized video 110, the polarized window 300, the polarized mirror 400, a first viewer 500 and a second viewer 502.

The first viewer 500 is shown viewing the polarized video 110 displayed on the polarized video viewing device 102. The first viewer 500 views the polarized video 110 through the polarized window 300, as previously shown in FIG. 3. As the direction of polarization of the polarized window 300 is generally equal to the direction of polarization of the first polarized video channel 112, as previously shown in FIG. 3, the viewer 302 views only the first polarized video channel 112.

The second viewer 502 is shown viewing the polarized video 110 displayed on the polarized video display device 102. The second viewer 502 views the polarized video 110 as reflected by the polarized mirror 400, as previously shown in FIG. 4. As the direction of polarization of the polarized mirror 400 is generally equal to the direction of polarization of the second polarized video channel 114, the viewer 302 views only the second polarized video channel 114 as previously shown in FIG. 4. In addition, as previously shown in FIG. 4, although the second viewer 502 views the polarized video 110 as a mirrored reflection, since the second video channel 114 includes the mirrored second title text 208 and the mirrored second closed captioning text 210, the second polarized channel is viewed with un-mirrored text when viewed in the mirror.

Referring again to FIG. 5, the polarized video display system components of FIG. 3 and FIG. 4 are combined to provide an embodiment of the polarized video display system 304 where different video channels are be displayed simultaneously on the same display and be viewable by different viewers depending on the location of the viewer and the polarization of the window or mirror that is used to view the polarized video display.

An exemplary use of the present invention is at a gym, where workout equipment is in different orientations and locations in the workout room. Typically workout rooms include one or more video display screens for users of the gym to view while exercising. It is also common for the video displays to be muted so as to not distract gym users who are not watching the video display or so that different video content may be shown on different display screen without also playing the different associated audios. Therefore, the video displays typically display the closed captioning text in lieu of the audio associated with the video.

Because of the number and types of equipment in a gym room, it is typical for some equipment to be oriented so that the user is facing a video display device 102, while other equipment is facing a mirror in which the video display device 102 is viewed. This allows users of various exercise equipment to view videos displayed on the video display device 102. However, the viewer 302 of the video reflected in the mirror will view the closed captioning text, and any other displayed text, as a mirror image, rendering it unreadable.

The present invention allows the viewer 302 of the polarized video 110 reflected in the mirror to view the closed captioning text and other displayed text in a non-mirrored orientation, while still allowing the viewer 302 with a direct line of sight to the polarized video display 102 to view the images and closed captioning in a normal manner.

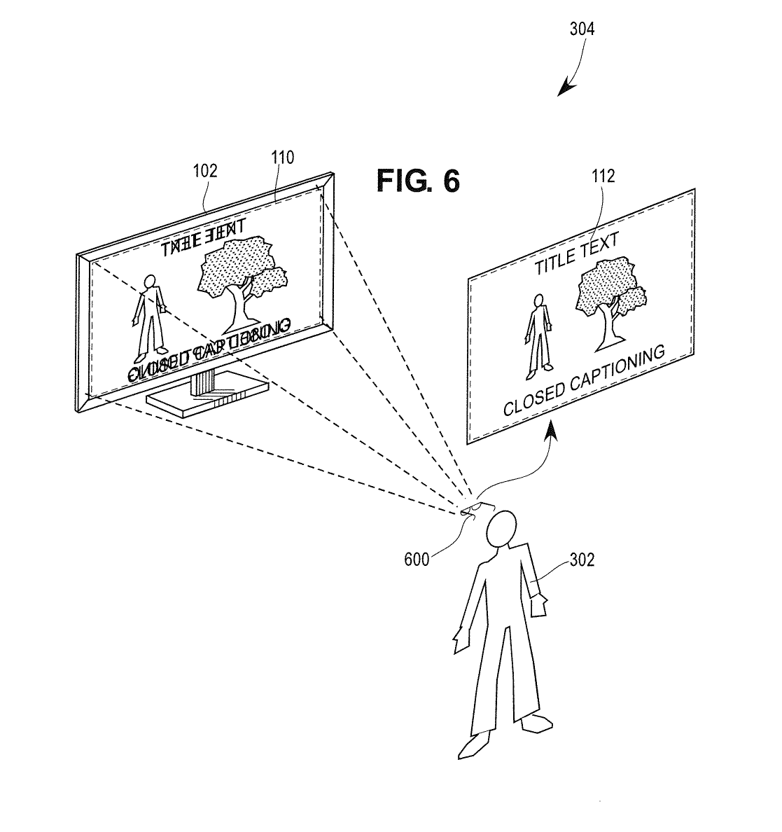

Referring next to FIG. 6, an alternate embodiment of the polarized video display system 304 is shown. Shown are the polarized video display device 102, the polarized video 110, the first polarized video channel 112, a pair of polarized glasses 600 and the viewer 302.

As previously shown in FIGS. 2-5, the polarized video 110 is displayed on the polarized video display device 102. The exemplary polarized video 110 includes the first and the second polarized video channels 112 114. The viewer 302 wears the polarized glasses 600, where the direction of polarization of the glasses 600 is generally equal to the direction of polarization of the first polarized video channel 112. The viewer 302 views the polarized video display device 102 through a direct line of sight.

Referring again to FIG. 6, since the direction of polarization of the polarized glasses 600 is generally equal to the direction of polarization of the first polarized video channel 112, only the first polarized video channel 112 is viewed by the viewer 302 wearing the polarized glasses 600. The polarized glasses 600 may be used in lieu of the polarized window 300 in order to view the first polarized video channel 112.

While the invention herein disclosed has been described by means of specific embodiments, examples and applications thereof, numerous modifications and variations could be made thereto by those skilled in the art without departing from the scope of the invention set forth in the claims.

1. A system for viewing polarized videos comprising:
a video display including means for displaying at least two polarized videos simultaneously;
at least two polarized videos,
wherein the polarized videos are displayed simultaneously on the video display,
wherein each polarized video includes a discrete direction of polarization,
a first polarized optical pane configured to be simultaneously viewed by both eyes, wherein the direction of polarization of the first polarized optical pane is generally equal to the direction of polarization of one of the polarized videos displayed on the video display,
whereby only one of the polarized videos displayed on the video display is viewable when viewed through the first polarized optical pane.

2. The system of claim 1 wherein the first polarized optical pane comprises a polarized mirror,
wherein a difference between an angle of the plane of the polarized mirror with respect to vertical and an angle of the plane of the video display with respect to vertical is less than or equal to 90 degrees, and
wherein a difference between an angle of the plane of the polarized mirror with respect to horizontal and an angle of the plane of the video display with respect to horizontal is less than or equal to 90 degrees, and
wherein a distance between the polarized mirror and the video display is such that the video display is viewable by a viewer looking at the polarized mirror.

3. The system of claim 2, wherein the polarized video includes text mirrored about a vertical axis.

4. The system of claim 1, wherein the first polarized optical pane comprises a polarized window, wherein a difference between an angle of the plane of the polarized window with respect to vertical and an angle of the plane of the video display with respect to vertical is less than or equal to 90 degrees, and
wherein a difference between an angle of the plane of the polarized window with respect to horizontal, and an angle of the plane of the video display with respect to horizontal, is less than or equal to 90 degrees, and
wherein a distance between the polarized window and the video display is such that the video display is viewable when the polarized window is located between a viewer and the video display.

5. (canceled)

6. The system of claim 1, further comprising a second polarized optical pane configured to be simultaneously viewed by both eyes, whereby only one of the polarized videos displayed on the video display is viewable when viewed through the second polarized optical pane.

7. The system of claim 6, wherein the first polarized optical pane comprises a first polarized mirror,
wherein a difference between an angle of the plane of the first polarized mirror with respect to vertical and an angle of the plane of the video display with respect to vertical is less than or equal to 90 degrees, and
wherein a difference between an angle of the plane of the first polarized mirror with respect to horizontal and an angle of the plane of the video display with respect to horizontal is less than or equal to 90 degrees, and
wherein a distance between the first polarized mirror and the video display is such that the video display is viewable by a viewer looking at the first polarized mirror;
and wherein the second polarized optical pane comprises a second polarized mirror,
wherein a difference between an angle of the plane of the second polarized mirror with respect to vertical and the angle of the plane of the video display with respect to vertical is less than or equal to 90 degrees, and
wherein a difference between an angle of the plane of the second polarized mirror with respect to horizontal and the angle of the plane of the video display with respect to horizontal is less than or equal to 90 degrees, and
wherein a distance between the second polarized mirror and the video display is such that the video display is viewable by the viewer looking at the second polarized mirror.

8. The system of claim 6, wherein the first polarized optical pane comprises a first polarized window,
wherein a difference between an angle of the plane of the first polarized window with respect to vertical and an angle of the plane of the video display with respect to vertical is less than or equal to 90 degrees, and
wherein a difference between an angle of the plane of the first polarized window with respect to horizontal, and an angle of the plane of the video display with respect to horizontal, is less than or equal to 90 degrees, and
wherein a distance between the first polarized window and the video display is such that the video display is viewable when the first polarized window is located between a viewer and the video display; and
wherein the second polarized optical pane comprises a first polarized mirror,
wherein a difference between an angle of the plane of the first polarized mirror with respect to vertical and the angle of the plane of the video display with respect to vertical is less than or equal to 90 degrees, and
wherein a difference between an angle of the plane of the first polarized mirror with respect to horizontal and the angle of the plane of the video display with respect to horizontal is less than or equal to 90 degrees, and
wherein a distance between the first polarized mirror and the video display is such that the video display is viewable by the viewer looking at the first polarized mirror.

9. The system of claim 6, wherein the first polarized optical pane comprises a first polarized window,
wherein a difference between an angle of the plane of the first polarized window with respect to vertical and an angle of the plane of the video display with respect to vertical is less than or equal to 90 degrees, and
wherein a difference between an angle of the plane of the first polarized window with respect to horizontal, and an angle of the plane of the video display with respect to horizontal, is less than or equal to 90 degrees, and
wherein a distance between the first polarized window and the video display is such that the video display is viewable when the first polarized window is located between a viewer and the video display; and
wherein the second polarized optical pane comprises a second polarized window,
wherein a difference between an angle of the plane of the second polarized window with respect to vertical and the angle of the plane of the video display with respect to vertical is less than or equal to 90 degrees, and
wherein a difference between an angle of the plane of the second polarized window with respect to horizontal, and the angle of the plane of the video display with respect to horizontal, is less than or equal to 90 degrees, and
wherein a distance between the second polarized window and the video display is such that the video display is viewable when the second polarized window is located between the viewer and the video display.

10. A method for viewing a polarized video through a polarized optical pane comprising:
providing a video display screen including means for displaying at least two polarized videos simultaneously,
providing at least two polarized videos displayed simultaneously on the video display screen,
wherein each of the at least two polarized videos includes a discrete direction of polarization; and
providing at least one polarized optical pane configured to be simultaneously viewed by both eyes, wherein a direction of polarization of the polarized optical pane is generally equal to a direction of polarization of one of the at least two polarized videos displayed on the video display screen,
whereby only one of the at least two polarized videos displayed on the video display screen is viewable when viewed through the polarized optical pane; and
viewing of the video display screen through the polarized optical pane,
whereby only the polarized video including the direction of polarization generally equal to the direction of polarization of the polarized optical pane is viewable.

11. The method of claim 10, wherein the polarized optical pane comprises a polarized mirror.

12. The method of claim 11, wherein the polarized video includes at least one mirrored text,
wherein the at least one mirrored text is mirrored about a vertical axis.

13. The method of claim 12, wherein the polarized video includes at least one mirrored image,
wherein the at least one mirrored image is mirrored about a vertical axis.

14. The method of claim 10, wherein the polarized optical pane comprises a polarized window.

15. A method for viewing a polarized video through a polarized optical element comprising:
providing a video display screen including means for displaying at least two polarized video channels simultaneously;
providing a first polarized video channel; and
providing a second polarized video channel,
whereby the first polarized video channel and the second polarized video channel are displayed simultaneously on the video display screen,
wherein each polarized video channel includes a discrete direction of polarization; and
providing a polarized window, wherein a direction of polarization of the polarized window is generally equal to a direction of polarization of the first polarized video channel,
whereby only the first polarized video channel is viewable when viewed through the polarized window; and
providing a polarized mirror, wherein a direction of polarization of the polarized mirror is generally equal to a direction of polarization of the second polarized video channel,
whereby only the second polarized video channel is viewable when viewed reflected by the polarized mirror; and
viewing of the first polarized video channel through the polarized window; and
viewing of the second polarized video channel through the polarized mirror.

16. The method of claim 15, wherein the second polarized video channel includes at least one mirrored text,
wherein the at least one mirrored text is mirrored about a vertical axis.

17. The method of claim 15, wherein the second polarized video channel includes at least one mirrored image,
wherein the at least one mirrored image is mirrored about a vertical axis.

18. A system for viewing polarized videos comprising:
a video display including means for displaying at least two polarized videos simultaneously;
a first polarized video, including a first direction of polarization, displayed on the video display, the first polarized video further including at least one non-mirrored text;
a second polarized video including a second direction of polarization discrete from the first direction of polarization, displayed on the video display simultaneously with the first polarized video, the second polarized video further including at least one mirrored text;
a pair of eyeglasses including polarized lenses, wherein a direction of polarization of the eyeglasses is generally equal to the first polarized direction, whereby the mirrored text is not viewed by a wearer of the eyeglasses.
